(19) United States
(12) Patent Application Publication
(10) Pub. No.: US 2019/0284041 A1
(43) Pub. Date: Sep. 19, 2019

(54) FUEL NOZZLE STORAGE ASSEMBLY

(71) Applicant: Em Hattum, Ponteix (CA)

(72) Inventor: Em Hattum, Ponteix (CA)

(21) Appl. No.: 15/923,154

(22) Filed: Mar. 16, 2018

(51) Int. Cl. B67D 7/42; B67D 7/84

(52) U.S. Cl. CPC B67D 7/421; B67D 7/04; B67D 7/845

(57) ABSTRACT

A fuel nozzle storage assembly for storing a refueling nozzle on a vehicle mounted refueling tank includes a housing that may be mounted to a bed of a service vehicle that has a refueling tank and a refueling nozzle. The housing insertably receives the refueling nozzle for storage to inhibit the refueling nozzle from becoming filled with dirt, snow or debris. A door is hingedly coupled to the housing and the door closes the housing. A drain is coupled to the housing to drain fuel that drips from the refueling nozzle outwardly from the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to storage devices and more particularly pertains to a new storage device for storing a refueling nozzle on a vehicle mounted refueling tank.

### BRIEF SUMMARY OF THE INVENTION

An embodiment of the disclosure meets the needs presented above by generally comprising a housing that may be mounted to a bed of a service vehicle that has a refueling tank and a refueling nozzle. The housing insertably receives the refueling nozzle for storage to inhibit the refueling nozzle from becoming filled with dirt, snow or debris. A door is hingedly coupled to the housing and the door closes the housing. A drain is coupled to the housing to drain fuel that drips from the refueling nozzle outwardly from the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fuel nozzle storage assembly according to an embodiment of the disclosure.

FIG. 2 is a bottom view of an embodiment of the disclosure.

FIG. 3 is a right side view of an embodiment of the disclosure.

FIG. 4 is a back view of an embodiment of the disclosure.

FIG. 5 is a left side phantom view of an embodiment of the disclosure.

FIG. 6 is a perspective in-use view of an embodiment of the disclosure.

### DETAILED DESCRIPTION OF THE INVENTION

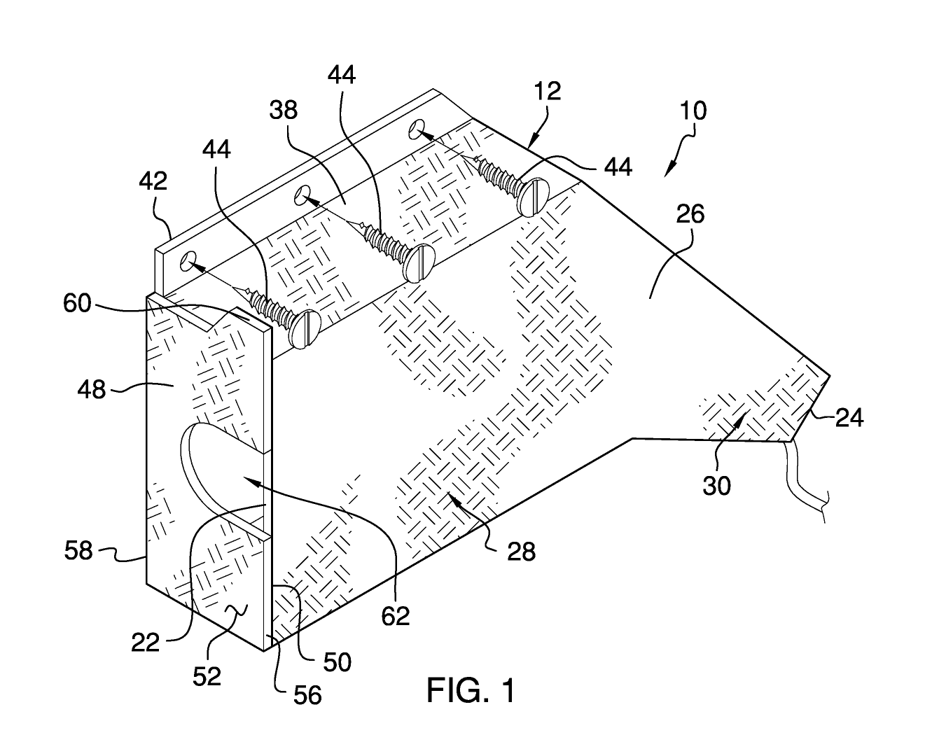

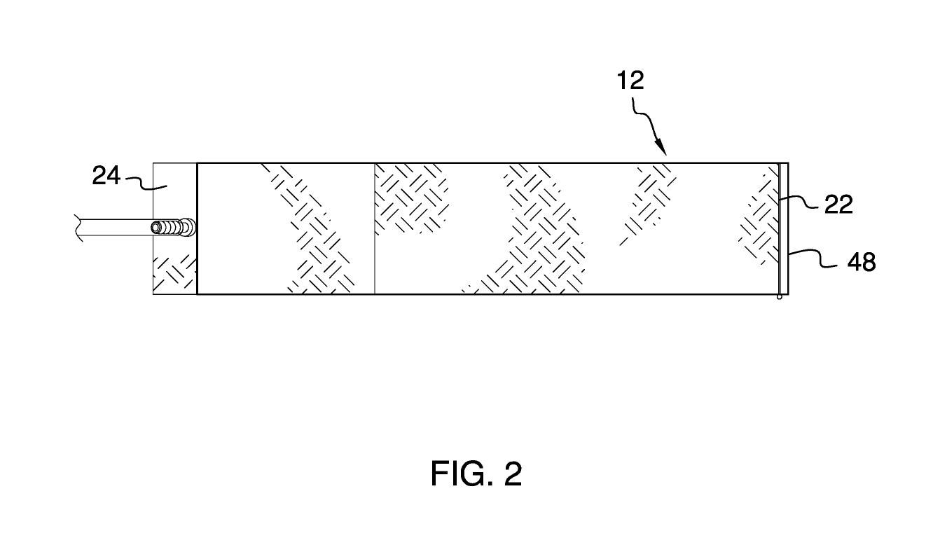

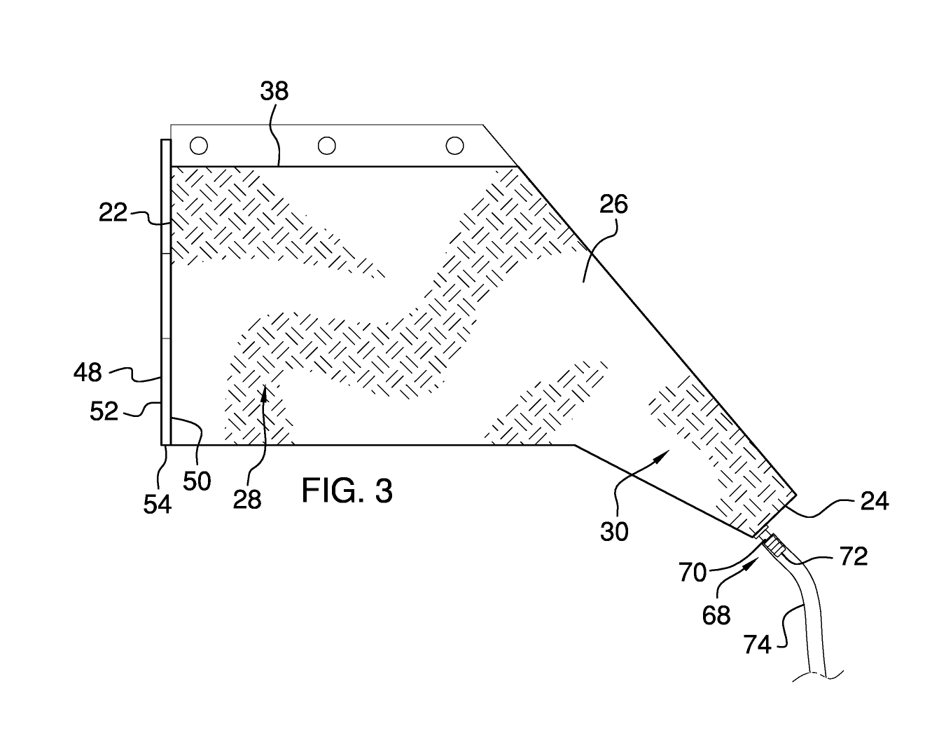

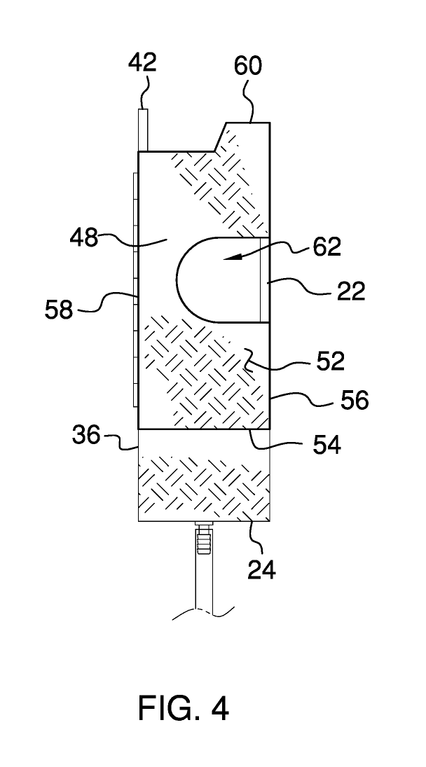

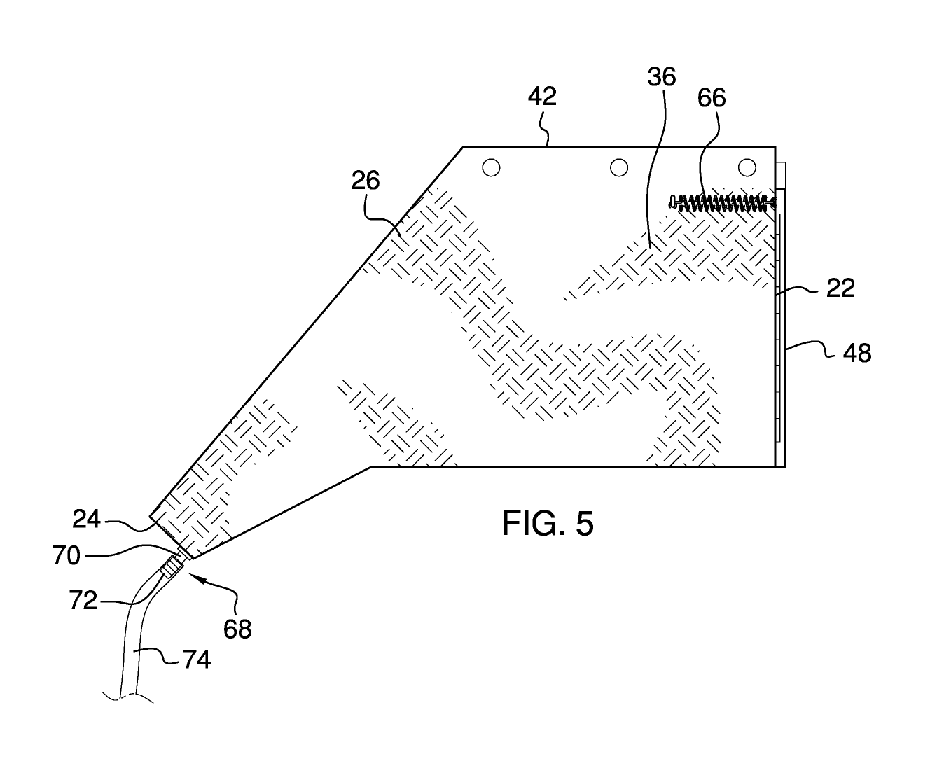

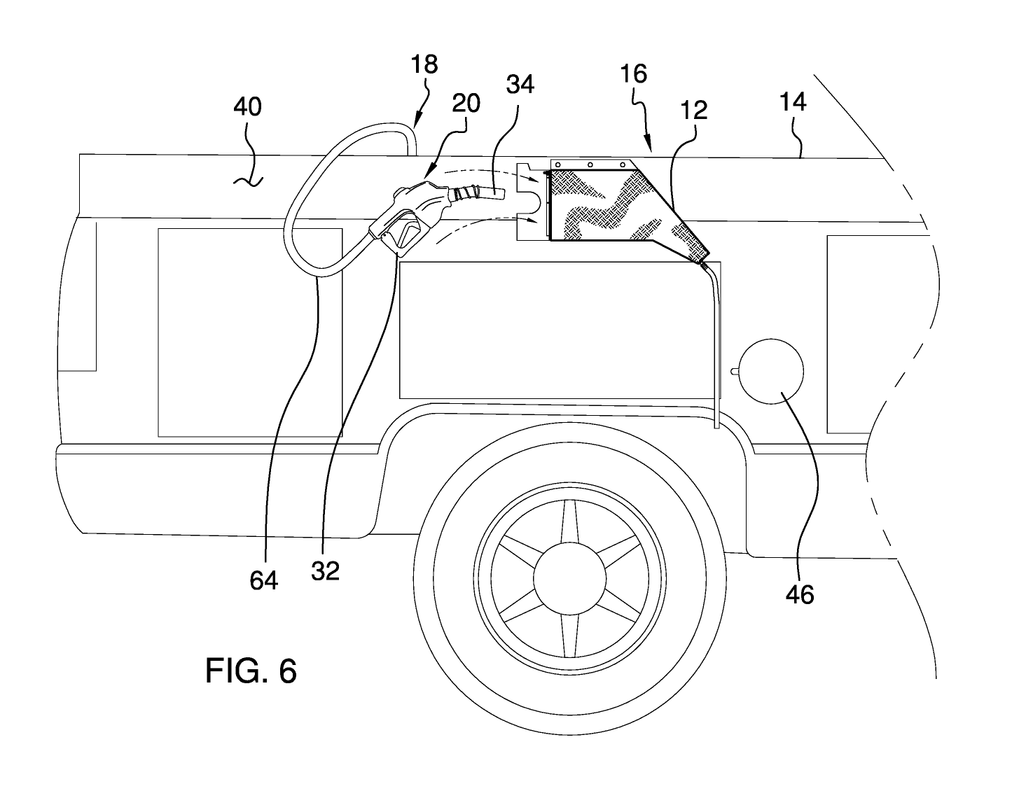

With reference now to the drawings, and in particular to FIGS. 1 through 6 thereof, a new storage device embodying the principles and concepts of an embodiment of the disclosure and generally designated by the reference numeral 10 will be described.

As best illustrated in FIGS. 1 through 6, the fuel nozzle storage assembly 10 generally comprises a housing 12 that may be mounted to a bed 14 of a service vehicle 16 that has a refueling tank 18 and a refueling nozzle 20. The service vehicle 16 may be a truck or the like and the refueling tank 18 may contain gasoline, diesel or other liquid fuel and the refueling nozzle 20 may be a refueling nozzle common to gasoline and diesel pumps. The housing 12 insertably receives the refueling nozzle 20 for storage to inhibit the refueling nozzle 20 from becoming filled with dirt, snow or debris. In this way the housing 12 enhances the service life of the refueling nozzle 20 and reduces the likelihood of malfunctions in the field as a result of a plugged refueling nozzle 20.

The housing 12 has a first end 22, a second end 24 and an outer wall 26 extending therebetween. The first end 22 is open to insertably receive the refueling nozzle 20 for storage. The outer wall 26 has a handle portion 28 and a spout portion 30 angling downwardly from the handle portion 28. Moreover, the handle portion 28 contains a handle 32 of the refueling nozzle 20 and the spout portion 30 contains a spout 34 of the refueling nozzle 20. The outer wall 26 has a first lateral side 36 and a top side 38, and the first lateral side 36 abuts an outside surface 40 of the bed 14 of the service vehicle 16. The handle portion 28 may have a length ranging between approximately 22.0 cm and 25.0 cm, and the spout portion 30 may have a length ranging between approximately 12.0 cm and 15.0 cm. Further, the housing 12 may have an overall length ranging between approximately 38.0 and 42.0 cm.

A lip 42 is coupled to and extends upwardly from the top side 38 of the outer wall 26 corresponding to the handle portion 28 of the housing 12. The lip 42 is aligned with the first lateral side 36 of the outer wall 26 of the housing 12 and a plurality of fasteners 44, such as screws or the like, are extended through the lip 42. Each of the fasteners 44 engages the outside surface 40 of the bed 14 the service vehicle 16 to retain the housing 12 on the service vehicle 16. Additionally, the housing 12 may be positioned adjacent to a refueling port 46 of the servicing vehicle.

A door 48 is hingedly coupled to the housing 12 such that the door 48 closes the housing 12. The door 48 has a first surface 50, a second surface 52 and a peripheral edge 54 extending therebetween. The peripheral edge 54 has a first lateral side 56 and a second lateral side 58, and the first lateral side 56 of the peripheral edge 54 of the door 48 is hingedly coupled to the first lateral side 36 of the outer wall 26 of the box. The first surface 50 of the door 48 abuts the first end 22 of the housing 12 when the door 48 is positioned in a closed position to close the first end 22 of the housing 12.

A tab 60 extends upwardly on the door 48 and beyond the top side 38 of the housing 12 and the tab 60 is gripped for opening the door 48. The second lateral side 58 has a slot 62 extending towards the first lateral side 56 of the door 48 and the slot 62 accommodates a fuel hose 64 on the refueling nozzle 20 when the refueling nozzle 20 is positioned in the housing 12. A biasing member 66 is coupled between the door 48 and the housing 12 to bias the door 48 into the closed position. The biasing member 66 may comprise a spring or the like.

A drain 68 is coupled to the housing 12 to direct fuel that drips from the refueling nozzle 20 outwardly from the housing 12. Thus, the drain 68 inhibits the fuel from collecting in the housing 12 when the refueling nozzle 20 is stored in the housing 12. The drain 68 comprises a nipple 70 that is coupled to the second end 24 of the housing 12 such that the nipple 70 is in fluid communication with an interior of the housing 12. The nipple 70 has a distal end 72 with respect to the second end 24 of the housing 12 and the distal end 72 is open to pass the fuel outwardly therefrom. A tube 74 is provided and the tube 74 insertably receives the distal end 72 of the nipple 70 such that the tube 74 is fluidly coupled to the nipple 70. Moreover, the tube 74 directs the fuel that drips from the refueling nozzle 20 down toward ground.

In use, the housing 12 is mounted to the outside surface 40 of the bed 14 of the service vehicle 16 and the housing 12 is positioned adjacent to the refueling port 46 on the service vehicle 16. Additionally, the housing 12 is positioned such that the door 48 on the housing 12 is directed toward a back side of the bed 14. The door 48 is opened and the refueling nozzle 20 is inserted into the first end 22 of the housing 12 having the spout 34 on the refueling nozzle 20 extending downwardly into the spout portion 30 of the housing 12 and having the handle 32 of the refueling nozzle 20 being positioned in the handle portion 28 of the housing 12. The door 48 is closed and the hose on the refueling nozzle 20 passes through the slot 62 in the door 48. Moreover, the drain 68 directs fuel that drips from the refueling nozzle 20 outwardly from the housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fuel nozzle storage assembly being configured to be mounted on a vehicle thereby facilitating a fuel nozzle to be stored, said assembly comprising:
a housing being configured to be mounted to a bed of a service vehicle having a refueling tank and a refueling nozzle, said housing insertably receiving the refueling nozzle for storage wherein said housing is configured to inhibit the refueling nozzle from becoming filled with dirt, snow or debris;
a door being hingedly coupled to said housing such that said door closes said housing; and
a drain being coupled to said housing wherein said drain is configured to drain fuel that drips from the refueling nozzle outwardly from said housing.

2. The assembly according to claim 1, wherein said housing has a first end, a second end and an outer wall extending therebetween, said first end being open wherein said first end is configured to insertably receive the refueling nozzle for storage, said outer wall having a first lateral side and a top side, said first lateral side being configured to abut an outside surface of the bed of the service vehicle.

3. The assembly according to claim 2, wherein said outer wall has a handle portion and a spout portion angling downwardly from said handle portion wherein said handle portion is configured to contain a handle of the refueling nozzle and said spout portion is configured to contain a spout of the refueling nozzle.

4. The assembly according to claim 2, further comprising a lip being coupled to and extending upwardly from said top side of said outer wall corresponding to said handle portion of said housing, said lip being aligned with said first lateral side of said outer wall of said housing, said lip being configured to be fastened to the outside surface of the bed the service vehicle to retain said housing on the service vehicle.

5. The assembly according to claim 2, wherein said door has a first surface, a second surface and a peripheral edge extending therebetween, said peripheral edge having a first lateral side and a second lateral side, said first lateral side of said peripheral edge of said door being hingedly coupled to said first lateral side of said outer wall of said box such that said first surface of said door abuts said first end of said housing when said door is positioned in a closed position to close said first end of said housing.

6. The assembly according to claim 5, wherein said second lateral side has a slot extending towards said first lateral side wherein said slot is configured to have a fuel hose on the refueling nozzle extending outwardly therethrough when the refueling nozzle is positioned in said housing.

7. The assembly according to claim 5, further comprising a biasing member being coupled between said door and said housing such that said biasing member biases said door into said closed position.

8. The assembly according to claim 2, wherein said drain comprises a nipple being coupled to said second end of said housing such that said nipple is in fluid communication with an interior of said housing, said nipple having a distal end with respect to said second end of said housing, said distal end being open wherein said distal end is configured to pass the fuel outwardly therefrom.

9. The assembly according to claim 8, further comprising a tube being coupled to said nipple wherein said tube is configured to direct the fuel outwardly from said nipple, said tube insertably receiving said distal end of said nipple such that said tube is fluidly coupled to said nipple.

10. A fuel nozzle storage assembly being configured to be mounted on a vehicle thereby facilitating a fuel nozzle to be stored, said assembly comprising:
a housing being configured to be mounted to a bed of a service vehicle having a refueling tank and a refueling nozzle, said housing insertably receiving the refueling nozzle for storage wherein said housing is configured to inhibit the refueling nozzle from becoming filled with dirt, snow or debris, said housing having a first end, a second end and an outer wall extending therebetween, said first end being open wherein said first end is configured to insertably receive the refueling nozzle for storage, said outer wall having a handle portion and a spout portion angling downwardly from said handle portion wherein said handle portion is configured to contain a handle of the refueling nozzle and said spout portion is configured to contain a spout of the refueling nozzle, said outer wall having a first lateral side and a top side, said first lateral side being configured to abut an outside surface of the bed of the service vehicle;
a lip being coupled to and extending upwardly from said top side of said outer wall corresponding to said handle portion of said housing, said lip being aligned with said first lateral side of said outer wall of said housing, said lip being configured to be fastened to the outside surface of the bed the service vehicle to retain said housing on the service vehicle;
a door being hingedly coupled to said housing such that said door closes said housing, said door having a first surface, a second surface and a peripheral edge extending therebetween, said peripheral edge having a first lateral side and a second lateral side, said first lateral side of said peripheral edge of said door being hingedly coupled to said first lateral side of said outer wall of said box such that said first surface of said door abuts said first end of said housing when said door is positioned in a closed position to close said first end of said housing, said second lateral side having a slot extending towards said first lateral side wherein said slot is configured to have a fuel hose on the refueling nozzle extending outwardly therethrough when the refueling nozzle is positioned in said housing;
a biasing member being coupled between said door and said housing such that said biasing member biases said door into said closed position; and
a drain being coupled to said housing wherein said drain is configured to drain fuel that drips from the refueling nozzle outwardly from said housing, said drain comprising:
a nipple being coupled to said second end of said housing such that said nipple is in fluid communication with an interior of said housing, said nipple having a distal end with respect to said second end of said housing, said distal end being open wherein said distal end is configured to pass the fuel outwardly therefrom; and
a tube being coupled to said nipple wherein said tube is configured to direct the fuel outwardly from said nipple, said tube insertably receiving said distal end of said nipple such that said tube is fluidly coupled to said nipple.
